(19) United States
(12) Patent Application Publication
(10) Pub. No.: US 2016/0151650 A1
(43) Pub. Date: Jun. 2, 2016

(54) FITTED FACE MASK

(71) Applicant: Prestige Ameritech, Ltd., North Richland Hills, TX (US)

(72) Inventor: George D. Reese, North Richland Hills, TX (US)

(21) Appl. No.: 14/954,685

(22) Filed: Nov. 30, 2015

Related U.S. Application Data
(60) Provisional application No. 62/086,401, filed on Dec. 2, 2014.

(51) Int. Cl. A62B 23/02; A62B 18/02; A41D 13/11

(52) U.S. Cl. CPC A62B 23/025; A41D 13/1161; A62B 18/025

(57) ABSTRACT

A facemask includes air-permeable filtering media for positioning over a wearer's nose and mouth, and peripheral portions adapted to fit the facemask to a wearer's face. The peripheral bottom portion includes an elongate elastic member anchored at its ends to the peripheral bottom portion proximate to or coincident with the opposing side portions and having a length in an extended state extending substantially across a width of the ungathered peripheral bottom portion. The elongate elastic member further includes an unattached portion between the anchored ends, which freely extends and relaxes without constraint to gather the peripheral bottom portion for engaging a chin and face of a wearer during use. The gathered peripheral bottom portion provides an air-inhibiting seal between the air-permeable filtering media and a wearer's face.

### CROSS-REFERENCE TO RELATED APPLICATIONS

This application claims the benefit of and priority to co-pending U.S. Provisional Application Ser. No. 62/086,401 entitled “FITTED FACE MASK,” filed Dec. 2, 2014, the entirety of which is hereby incorporated herein by reference thereto.

### FIELD OF DISCLOSURE

The present disclosure relates generally to facemasks and, in particular, to a facemask with improved face fit.

### BACKGROUND

Face fit is an important feature of any facemask, particularly for those used in the health and surgical industry. Such facemasks typically comprise a porous filtering media for filtering particulate matter and bacteria, preferably from both inhaled and exhaled air. Ties or other fastening means are typically used to hold the porous filtering media over a wearer's mouth and nose when in use.

To prevent unfiltered air from flowing through any gaps that exist between the face of a wearer and the periphery of the facemask in use, thereby bypassing the porous filtering media, it is desired to form an airtight seal between the edges of the porous filtering media and a wearer's face. Various types of peripheral seals have been proposed in the prior art, with varying degrees of success. Some of the proposed solutions, while seemingly useful in theory, have proven to be impractical to manufacture.

A need exists, therefore, for facemasks with improved fit. A need also exists for facemasks with improved fit that can be manufactured in a cost-effective manner.

### SUMMARY

Features of the disclosure will become apparent from the following detailed description considered in conjunction with the accompanying drawings. It is to be understood, however, that the drawings are designed as an illustration only and not as a definition of the limits of this disclosure.

The present disclosure is directed to a facemask including an air-permeable filtering portion comprising air-permeable filtering media. The air-permeable filtering media of the facemask in use by a wearer is configured to position over a wearer's nose and mouth to provide an air path therethrough. The facemask also includes a peripheral top portion, a peripheral bottom portion, and opposing side portions connecting the peripheral top portion to the peripheral bottom portion, the peripheral top, bottom, and opposing side portions forming a periphery adapted to fit the facemask to a wearer's face.

The peripheral bottom portion includes an elongate elastic member. The elongate elastic member is anchored at its ends to the peripheral bottom portion, each end being anchored proximate to or coincident with each of the opposing side portions. The elongate elastic member has a length in an extended state (an extended length) extending substantially across an ungathered width of the peripheral bottom portion. The elongate elastic member further includes an unattached portion between the anchored ends, which can freely extend and relax without constraint to gather the peripheral bottom portion for engaging a chin and face of a wearer during use. During use, the gathered peripheral bottom portion provides an air-inhibiting seal between the air-permeable filtering portion and a wearer's face.

In one aspect, a channel is formed within the peripheral bottom portion. The unattached portion of the elongate elastic member is positioned within the channel to gather the peripheral bottom portion between the anchored ends.

In another aspect, the facemask further includes a pair of ear loops. Each pair of ear loops has an upper end fixed to the peripheral top portion and a lower end fixed to the peripheral bottom portion, the upper and lower end being positioned along one of the opposing side portions for looping around an ear of a wearer.

In aspects, the peripheral top portion may include a thin bendable strip of material for conforming to a shape of a wearer's nose.

In additional aspects, the peripheral top portion, the peripheral bottom portion, and the opposing side portions may include a material that inhibits the flow of air therethrough.

In a further aspect, the elongate elastic member is anchored to the peripheral bottom portion at an additional position between the opposing side portions.

In aspects, the facemask further includes a headband configured for retaining the facemask on a wearer's face, each end of the headband being fixed to one of the opposing side portions.

In other aspects, the facemask, further includes at least one pair of ties configured for retaining the facemask on a wearer's face, one end of each tie being fixed to one of the opposing side portions.

In still additional aspects, the facemask further includes a pair of ear loops, each pair having an upper end fixed to the peripheral top portion and a lower end fixed to the peripheral bottom portion, the upper and lower end being positioned along one of the opposing side portions for looping around an ear of a wearer.

Each of the upper end and the lower end may be fixed by one of ultrasonic welding, gluing, sewing, and combined heat and pressure.

In aspects, each of the ends of the elongate elastic member is fixed to the peripheral bottom portion of the facemask by one of ultrasonic welding, gluing, sewing, stapling, and combined heat and pressure.

The present disclosure is also directed to a facemask that includes an air-permeable filtering portion comprising air-permeable filtering media, the air-permeable filtering portion being configured for positioning over a wearer's nose and mouth to provide an air path therethrough. A peripheral top portion, a peripheral bottom portion, and opposing side portions of the facemask connect the peripheral top portion to the peripheral bottom portion, the peripheral top, bottom, and opposing side portions forming a periphery adapted to fit the facemask to a wearer's face.

The peripheral bottom portion includes at least one elongate elastic member. The at least one elongate elastic member has an extended length that is stretched beyond its relaxed length. The extended length of the elongate elastic member is positioned lengthwise along the peripheral bottom portion between a first position and a second position of the peripheral bottom portion. A first end of the extended length of the at least one elongate elastic member is anchored at the first position and a second end is anchored at the second position. The extended length corresponds to an ungathered width separating the first position from the second position for gathering a section of the peripheral bottom portion between the first position and the second position. The at least one elongate elastic member further includes an unattached portion between the first and second anchored ends, which freely extends and relaxes without constraint to gather the section of the peripheral bottom portion for engaging a chin and face of a wearer during use. The gathered peripheral bottom portion provides an air-inhibiting seal between the air-permeable filtering portion and a wearer's face.

In one aspect, a channel is formed within the peripheral bottom portion, the unattached portion of the at least one elongate elastic member being positioned within the channel for freely extending and relaxing without constraint to gather the peripheral bottom portion for engaging a chin and face of a wearer during use.

In aspects, the extended length extends across at least half a width of the facemask.

In further aspects, the at least one elongated elastic member includes two or more elongated elastic members. A combined extended length of the two or more elongated elastic members extends substantially across the ungathered width of the peripheral bottom portion.

In additional aspects, the facemask further includes a pair of ear loops, each pair having an upper end fixed to the peripheral top portion and a lower end fixed to the peripheral bottom portion, the upper and lower end being positioned along one of the opposing side portions for looping around an ear of a wearer.

Each of the upper end and the lower end may be fixed by one of ultrasonic welding, gluing, sewing, and combined heat and pressure.

In still additional aspects, the peripheral top portion includes a thin bendable strip of material for conforming to a shape of a wearer's nose.

In further aspects, each of the first end and the second end of the at least one elongate elastic member is fixed to the peripheral bottom portion by one of ultrasonic welding, gluing, sewing, stapling, and combined heat and pressure.

In still additional aspects, the facemask may include at least one pair of ties configured for retaining the facemask on a wearer's face, one end of each tie being fixed to one of the opposing side portions.

For any of the retaining members for retaining the facemask on a wearer's face, including ear loops, ties, and headband, each of the ends may be fixed by ultrasonic welding, gluing, stapling, sewing, or heat and pressure.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the drawings.

FIG. 1A is a pictorial representation of a front of a conventional, prior art facemask.

FIG. 1B is a pictorial representation of a portion of the prior art facemask of FIG. 1A donned by a wearer.

FIG. 2A is a pictorial representation of a front of an embodiment of a facemask of the present disclosure.

FIG. 2B is a pictorial representation of the front of the facemask of FIG. 2A, with the pleats expanded for donning by a wearer.

FIG. 3A is another pictorial representation of the front of the embodiment of the facemask shown in FIG. 2A.

FIG. 3B is a pictorial representation of the front of another embodiment of the facemask shown in FIG. 2A.

FIG. 4 is a pictorial representation of a back of a facemask of the present disclosure, after it has been altered to expose the elongate elastic member that is normally enclosed in a channel formed in the peripheral bottom portion.

FIG. 5 is a pictorial representation of a back of another embodiment of a facemask formed in accordance with the present disclosure.

FIG. 6 is a pictorial representation of a back of yet another embodiment of a facemask formed in accordance with the present disclosure.

FIG. 7 is a pictorial representation of a portion of air-filtering media included in an embodiment of a facemask of the present disclosure.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure is directed to a fitted facemask, which includes an elongate elastic member that is anchored at its ends to a peripheral bottom portion of the facemask, and which is positioned and configured to gather the peripheral bottom portion for engaging a chin and face of a wearer during use. The gathered peripheral bottom portion provides an air-inhibiting seal between the air-permeable filtering media and a wearer's face.

One of skill in the art can appreciate that the elongated elastic member has a length in a relaxed, unperturbed state that is shorter than its length when stretched. The term “extended length” is used herein to refer to a length of the elastic member when stretched beyond its relaxed state.

Prior to assembly of the elongated elastic member to the peripheral bottom portion of the facemask of the present disclosure, the peripheral bottom portion has a width that is referred to herein as an “ungathered width.” “Ungathered width” refers herein to a distance between two points along an unassembled (ungathered) peripheral bottom portion. As described further herein, once the ends of the elongate elastic member are anchored to the peripheral bottom portion as provided, the unattached portion of the elongate elastic member as well as the section of the peripheral bottom portion between the anchored ends are allowed to stretch and relax as needed for engaging a chin and face of a wearer during use, providing an air-inhibiting seal between the air-permeable filtering portion and a wearer's face. The term “gathered peripheral bottom portion” is sometimes used herein to refer to the peripheral bottom portion assembled for use (with the elongate elastic member). During use, the gathered peripheral bottom portion between the anchored ends may contract and extend as needed to fit the mask to a wearer's face.

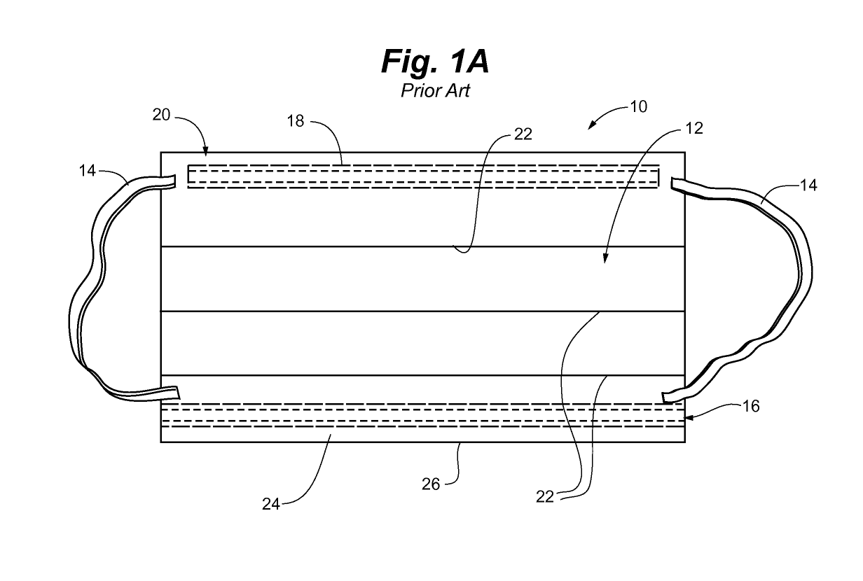

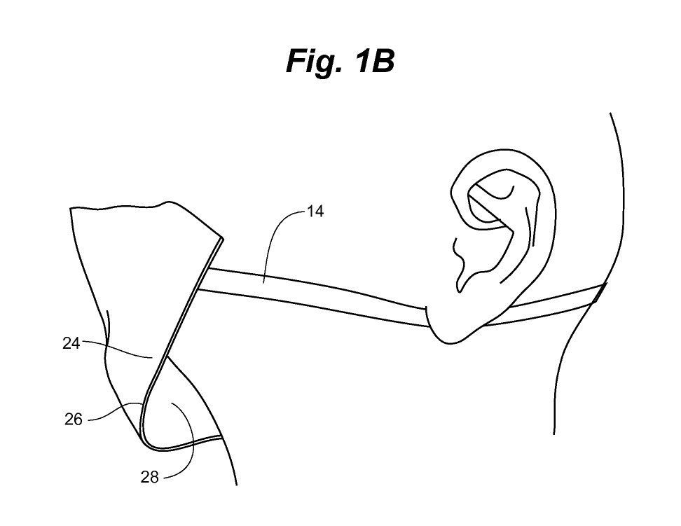

Referring to FIG. 1A, a conventional facemask 10 includes an air-filtering portion 12, and ear loops 14 attached to a periphery 16 of the facemask 10 for positioning and retaining the air-filtering portion 12 over a mouth and nose of a wearer. The facemask 10 may include a thin bendable strip of aluminum, steel, or plastic sewn into a seam formed along an upper edge or enclosed in a channel 18 formed by any suitable method across an upper peripheral portion 20 of the mask 10. The thin bendable strip (visible below an upper layer of the channel 18 in FIG. 1A) may be bent to conform around a top of a wearer's nose in use, to help fit the top edge of the facemask 10 to a wearer's face. The air-filtering portion 12 may also include a plurality of pleats 22 that allow vertical expansion of the air-filtering portion 12 upon donning of the mask 10 to cover a nose and mouth of a wearer and, preferably, to extend beyond the chin in a vertical direction.

Referring also to FIG. 1B, one problem presented by the conventional facemask 10 of FIG. 1A, as well as by other types of facemasks known in the art, is imperfect face fit of the mask 10 to a wearer's face. Imperfect face fit can result in unfiltered air passing through gaps formed between the mask 10 and a wearer's face at the periphery 16 of the facemask 10. The air which enters or exits through such gaps caused by imperfect face fit bypasses the air-filtering media 12, thereby allowing unfiltered air to be exhaled into the environment, and/or to be inhaled by the wearer. As shown in FIG. 1B, the lower periphery 24 of the facemask 10 is particularly troublesome, since a substantial portion of the lower periphery 24 and bottom edge 26 does not contact the neck or chin of most wearers, leaving large gaps 28 through which unfiltered air may pass.

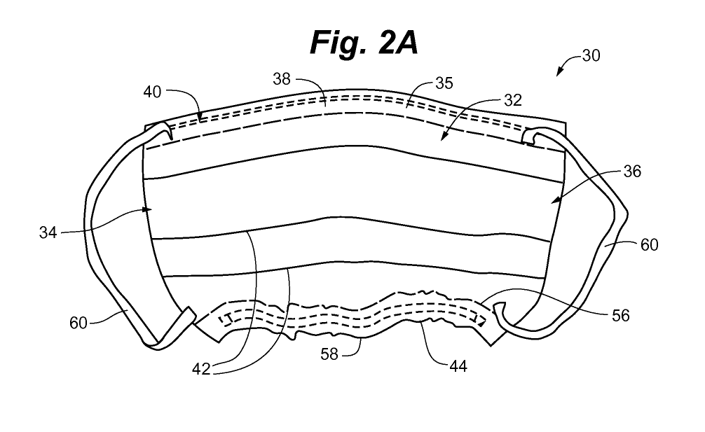

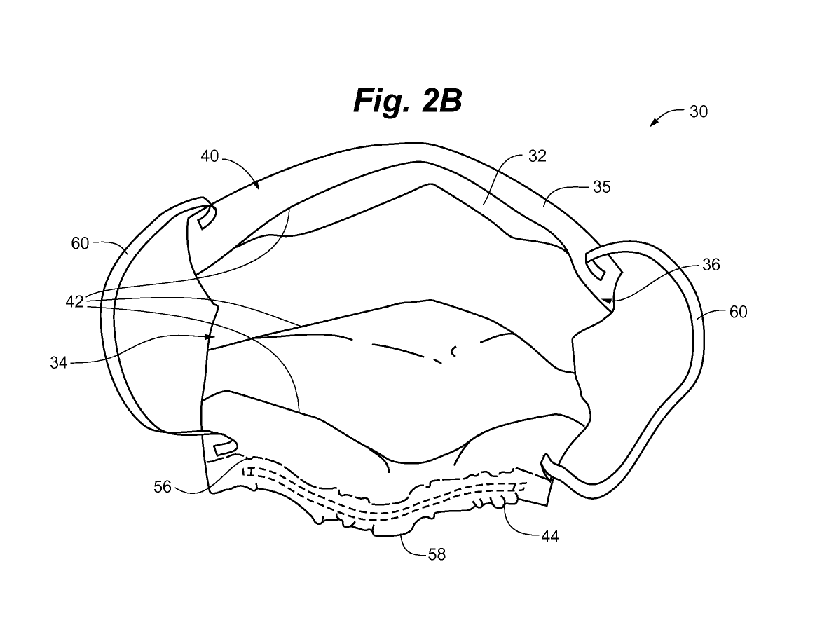

The present disclosure provides a facemask having improved face fit compared to a conventional facemask, such as the mask 10 shown in FIG. 1A and FIG. 1B. Referring to FIG. 2A, an embodiment of a facemask 30 in accordance with the present disclosure includes an air-filtering portion comprising an air-permeable filtering media 32 for positioning over a mouth and nose of a wearer to provide an air path therethrough. Air is filtered through the filtering media 32 upon both inhalation and exhalation. The filtering media 32 can be a breathable multi-layered structure, which is connected around its periphery to opposing side portions 34 and 36, a peripheral top portion 40 and peripheral bottom portion 44.

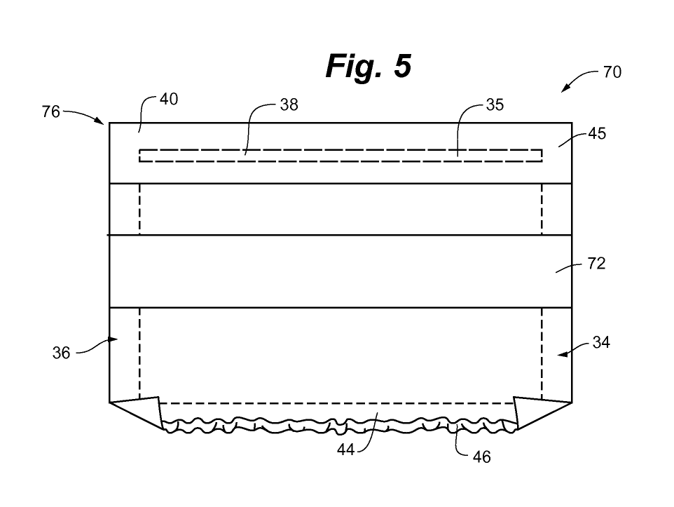

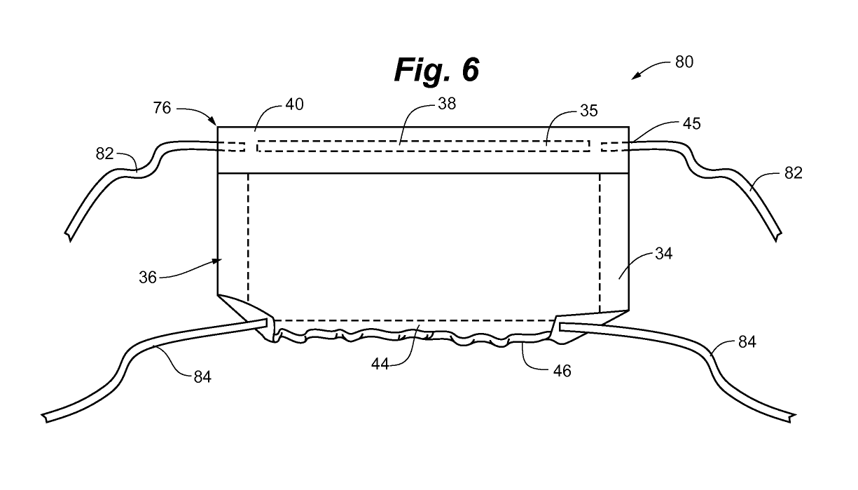

In some embodiments, each of the sides 34, 36, top 40 and bottom portions 44 are configured to inhibit the flow of air therethrough. In embodiments, the filtering media 32 is sealed around its periphery to form opposing side portions 34, 36 (see also FIGS. 5 and 6) and top 40 and bottom portions 44. For example, these peripheral portions may include a binding strip used to seal the side edges of the multi-layered structure together. One of ordinary skill in the art will appreciate that the binding strip is typically folded over, so that the fold forms an edge of the facemask. In other embodiments, the multi-layered structure is sealed between two separate binding strips. The peripheral edges of the multilayered structure are placed within the open side of the fold, or between two separate binding strips, and the edges of the multilayered structure are sealed within the folded binding strip, or between two binding strips. In various embodiments, the binding strip(s) may be sealed by sewing, gluing, ultrasonically welding, stapling, or sealing around the periphery of the filtering media 32 with a combination of heat and pressure.

Referring still to FIG. 2A, in embodiments, the facemask 30 also includes a thin bendable strip of aluminum, steel, or plastic sewn into a seam formed along an upper edge or enclosed in a channel 38 formed by any suitable method across the top peripheral portion 40 of the mask 30. The thin bendable strip 35 (visible below an upper layer of the channel 38 in FIG. 2A) may be bent to conform around a top of a wearer's nose in use, to help fit the top edge of the facemask 30 to a wearer's face.

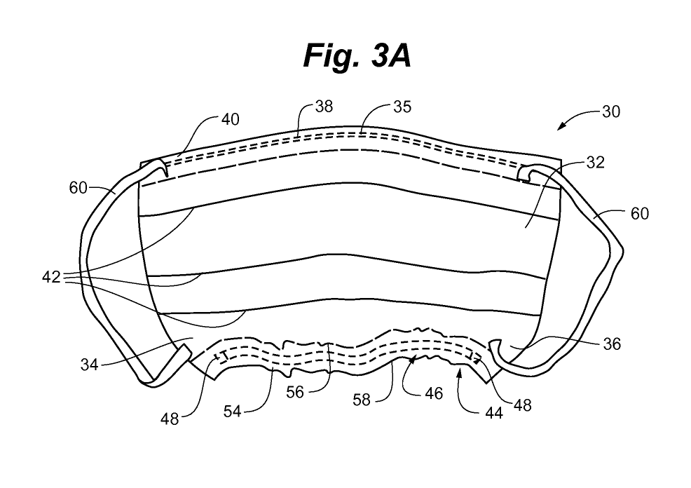

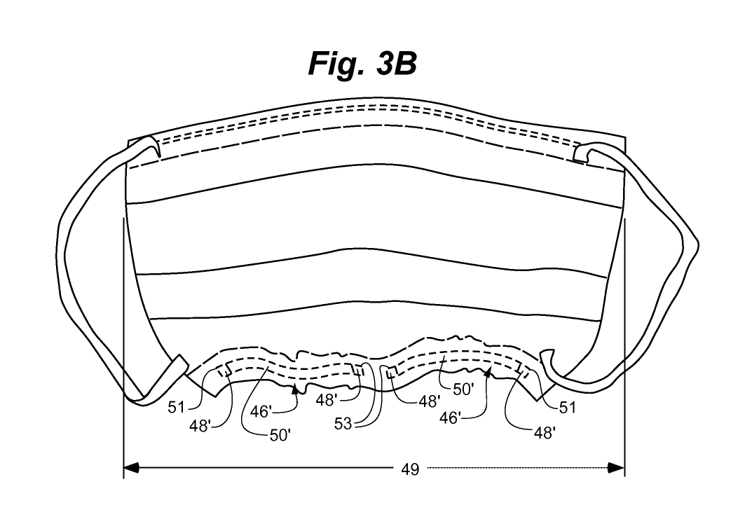

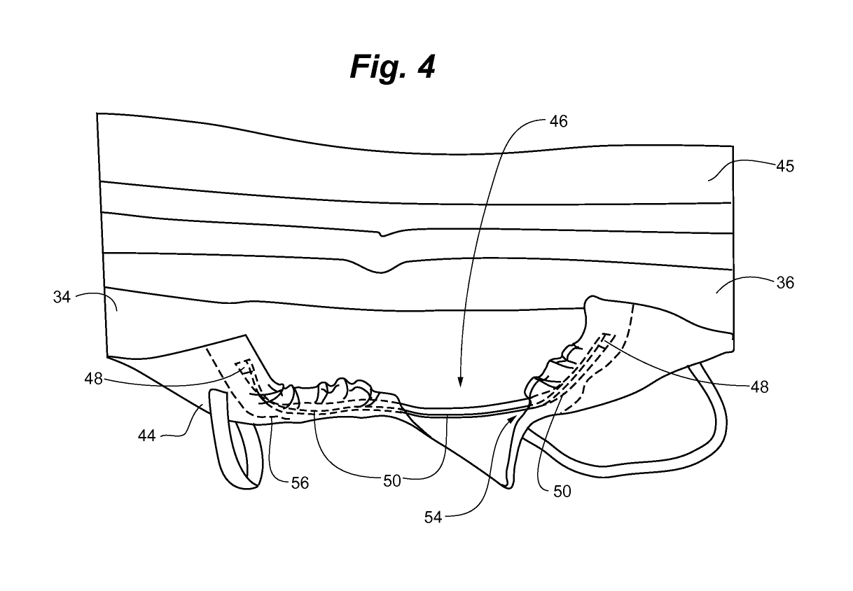

Referring also to FIGS. 3A, 3B and 4, to enhance the face fit, the peripheral bottom portion 44 of the facemask 30 includes an elongate elastic member 46 configured to stretch and pull the facemask 30 tight against a user's chin, neck, and face in use, reducing and, preferably, eliminating, the number and size of any gaps through which unfiltered air may pass. As indicated by the dashed lines outlining the elongate elastic member in FIGS. 2A through 4, in the embodiments shown, the elongate elastic member is not visible to the user, but is positioned within a channel as described further herein. The elongate elastic member 46 is anchored at its ends 48 to two positions along the peripheral bottom portion 44. A distance between the two positions along an unassembled peripheral bottom portion 44, referred to herein as an ungathered width, corresponds to an extended length of the elongate elastic member. Accordingly, in use, the peripheral bottom portion 44 can extend to its full (ungathered) width and relax, or gather, as needed to engage a chin and face of a wearer.

In embodiments, the ends 48 are anchored to positions proximate to, or coincident with, the opposing side portions 34, 36 so that the extended length of the elastic member 46 extends across a substantial portion of the entire peripheral bottom portion 44, an unattached portion 50 of the elastic member preferably extending across the width of the air-permeable filtering media 32 between the opposing side portions 34, 36. In other embodiments, the elastic member 46 extends across the entire peripheral bottom portion 44.

In embodiments, the ends 48 are anchored at positions on the peripheral bottom portion such that the elongate elastic member 46 is substantially centered along the peripheral bottom portion 44 for engaging the chin and neck area of the wearer.

Referring, for example, to FIG. 3B, in embodiments, the peripheral bottom portion 44 includes at least one elongate elastic member 46′. One end 48′ of an extended length of the elongate elastic member 46′ is anchored at a first position 51 and the other end 48′ is anchored at a second position 53. The ungathered width of the section of the peripheral bottom portion 44 between the first 51 and second 53 position corresponds to the extended length of the elongate elastic member 46′. During use, the unattached portion 50′ between the anchored ends 48′ can then freely extend and relax without constraint to gather the section of the peripheral bottom portion between the first and second position for engaging a chin and face of a wearer.

In further embodiments, still referring to FIG. 3B, the at least one elongated elastic member 46′ may include two or more elongated elastic members, positioned end to end lengthwise across the peripheral bottom portion 44. A combined extended length of the two or more elongated elastic members preferably extends substantially across the ungathered width 49 of the peripheral bottom portion, extending at least to the opposing side portions. In embodiments, the combined unattached portions 50′ extend across the width of the air-permeable filtering media, between the sealed opposing side portions.

In embodiments, the extended length of the elongate elastic member 46 is attached across at least half the (ungathered) width 49 of the peripheral bottom portion. Referring to FIG. 3B, in one embodiment, two elastic members 46′ are positioned end to end along bottom portion 44, such that their combined extended length extends across a substantial portion of the ungathered width 49. One of each of the ends 48′ is anchored at a first position 51 proximate an opposing side portion 34, 36. The remaining end is anchored at a second position 53 preferably near a midline of the width 49.

It should be understood that the ends of the elongate elastic member 46 of the present disclosure do not necessarily need to be anchored during manufacturing while the member 46 is in an extended state. Any appropriate method for manufacturing the fitted face mask of the present disclosure is within the scope of the present disclosure.

Referring particularly to FIG. 4, the elongate elastic member 46 has an unattached portion 50 between the anchored ends which can freely extend and relax without constraint to gather the peripheral bottom portion for engaging a chin and face of a wearer during use. The gathered peripheral bottom portion 44 provides an air-inhibiting seal between the air-permeable filtering media 32 and a wearer's face.

Referring to FIGS. 3A, 3B and 4, in embodiments as shown, the peripheral bottom portion 44 includes a channel 54 for capturing the unattached portion 50 therein. The channel may be formed, for example, between a seam 56 and a bottom edge 58 of the facemask. Seam 56 may also form the bottom edge of the sealed portion of the periphery of the filtering media 32. The unattached portion 50 of the elongate elastic member 46 is positioned within the channel 54 and is free to extend and relax, within the channel 54 to gather the peripheral bottom portion between the anchored ends 48. The seam 56 may be formed by any appropriate method known in the art, including, but not limited to, ultrasonic welding, gluing, and sealing with a combination of heat and pressure.

Anchored ends 48 may be fixed to the peripheral bottom portion 44 by any method known in the art, including, but not limited to, ultrasonic welding, gluing, sewing, stapling, and a combination of heat and pressure. In embodiments, the ends may be fixed by any of the same methods used to seal the edges of the (multi-layer) filtering media. In embodiments, the step of sealing the side edges and anchoring the ends of an elongated elastic member to the side edges, i.e., coincident with the side edges, may be performed in a single processing step. In embodiments, the anchored ends 48 may be fixed within a folded binding strip or between separate binding strips used to seal the side edges of the air-permeable filtering media together, so that the unattached portion 50 is captured within the channel 54. In other embodiments, the ends 48 may be affixed to a layer of the facemask 30, for example, onto an outer or inner layer of the facemask 30.

The elongate elastic member 46 may, in some embodiments, comprise additional anchoring ends 48 along its length, which are fixed to the peripheral bottom portion in accordance with the present disclosure.

The elongate elastic member of the present disclosure can be any appropriate elastic band, strip, or other appropriate elasticized material known in the art. In embodiments, the elongate elastic member is a knitted elastic. In other embodiments, the elongate elastic member is an elastomeric, such as a LYCRA®, SPANDEX®, rubber, or latex material or blends thereof. In embodiments, the elongate elastic material includes any appropriate stretchy material including stretch knits and the like.

As described herein, the elongate elastic material of the present disclosure is extended beyond its relaxed length and anchored at two positions on the peripheral bottom portion, such that the extended length corresponds to the ungathered width between the two positions. In embodiments, the extended length as anchored to the two positions, and the corresponding ungathered width between the two positions, is at least 10% greater than the relaxed length of the elongate elastic member.

In embodiments, the extended length and corresponding ungathered width between the two positions is between about 10% to about 15% greater than the relaxed length of the elongate elastic member.

In embodiments, the extended length and corresponding ungathered width between the two positions is between about 10% to about 40% greater than the relaxed length of the elongate elastic member.

In embodiments, the extended length and corresponding ungathered width between the two positions is between about 20% to about 30% greater than the relaxed length of the elongate elastic member.

Referring also to FIG. 2B, in embodiments, the air-filtering portion comprising the air-permeable filtering media 32 also includes a plurality of pleats 42 that allow vertical expansion of the air-permeable filtering media 32 upon donning of the mask 30 to facilitate covering a nose and mouth of a wearer and, in cooperation with the gathered peripheral bottom portion 44, to engage the chin of a wearer.

In additional embodiments, the facemask of the present disclosure includes ear loops 60 for retaining the air-permeable filtering media 32 in position over the mouth and nose of the wearer. Each end of an ear loop 60 may be attached to peripheral top 40 and bottom portions 44, respectively, along one of the sides 34, 36 of the facemask 30. It has been surprisingly discovered that the combination of the ear loops and gathered peripheral bottom portion 44 both engages and seals the chin and neck area and lifts and pulls the side portions of the mask to enhance the overall face fit of the mask 30, eliminating the need for additional elasticized or other types of seals being added to the sides of the mask 30. Accordingly, the manufacturing cost associated with producing an enhanced face-fitting mask in accordance with the present disclosure is reduced in comparison to prior art facemasks.

In other embodiments, as shown in FIG. 5, a headband 72, formed of any appropriate stretchable material, may be used as a retaining member for retaining the air-permeable filtering media 32 in position over the mouth and nose of the wearer during use. The headband 72 may be formed, for example, but not limited to, stretchable non-woven materials or laminates. Each end of the headband 72 may be attached to the back 76 of the facemask 70, for example, at each opposing side 34, 36 of the facemask 70. In use, the headband 72 is stretched over the back of a wearer's head, while the bottom peripheral portion 44, with the elongate elastic member 46 attached in accordance with the present disclosure, is positioned and stretched to engage the wearer's chin. The headband 72, in some embodiments, is positioned nearer the top peripheral portion 40 than the bottom peripheral portion 44. As shown in FIG. 5 as well as in FIG. 4, for the wearer's comfort, an additional soft pad 45 is, in some embodiments, attached to the back of the facemask over the top peripheral portion 40 (which may include the bendable strip 35 as described above). The soft pad 45 may be formed of any suitable material, for example, a thin foam or a nonwoven material. The ends of the headband 72 may be attached to the periphery of the mask 70 by any method known in the art, including, but not limited to, ultrasonic welding, stapling, gluing, sewing, and a combination of heat and pressure.

In still other embodiments, as shown in FIG. 6, a pair of ties 82, formed of any appropriate, preferably non-stretchable material, may be used for retaining the air-permeable filtering media 32 in position over the mouth and nose of the wearer during use. One end of each of the ties 82 is attached to each opposing side 34, 36 of the facemask 80 along the top peripheral portion 40. In use, the free ends of the ties 82 are extended and tied around a wearer's head, while the bottom peripheral portion 44 of the facemask 80 is positioned and stretched to engage the wearer's chin. In embodiments, as shown, a second pair of ties 84 may also be attached to each opposing side 34, 36 of the facemask 80 along the bottom peripheral portion 44 for extending and tying around a wearer's head. The ends of the ties, in some embodiments, may be attached to the periphery of the mask 80 by any method known in the art, including, but not limited to, ultrasonic welding, stapling, gluing, sewing, and a combination of heat and pressure. In other embodiments, the ties may be an extension of a binding strip that forms an edge, as described herein, for example, of a top or bottom edge, of the facemask 80.

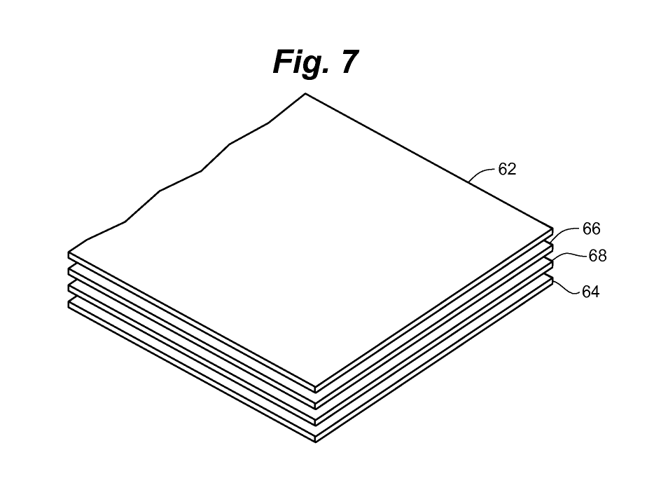

Referring to FIG. 7, the air-permeable filtering media 32 of the facemask of the present disclosure may be a multilayered structure including any combination of various layers for filtering and/or absorbing unwanted particulates, bacteria, and other contaminants according to the particular use of the facemask. For example, in embodiments, the air-filtering media 32 may include an outer layer 62 of a nonwoven, spunbond material, and an inner, face-side, layer 64 of a nonwoven cellulose or other material that is appropriate for contact with a wearer's face. Any number of intermediate layers 66, 68 may also be included. For example, intermediate layers 66 and 68 may be formed of different nonwoven melt-blown and/or spunbond materials, which additionally may be electrostatically charged, in accordance with methods known in the art.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A facemask comprising:
an air-permeable filtering portion comprising air-permeable filtering media, the air-permeable filtering portion configured for positioning over a wearer's nose and mouth to provide an air path therethrough; and
a peripheral top portion, a peripheral bottom portion, and opposing side portions connecting the peripheral top portion to the peripheral bottom portion, the peripheral top, bottom, and opposing side portions forming a periphery of the facemask adapted to fit the facemask to a wearer's face,
wherein the peripheral bottom portion includes an elongate elastic member, the elongate elastic member being anchored at its ends to the peripheral bottom portion, each end being anchored proximate to or coincident with each of the opposing side portions, the elongate elastic member having a length in an extended state extending substantially across an ungathered width of the peripheral bottom portion, the elongate elastic member further comprising an unattached portion between the anchored ends, the unattached portion freely extending and relaxing without constraint to gather the peripheral bottom portion for engaging a chin and face of a wearer during use, the gathered peripheral bottom portion providing an air-inhibiting seal between the air-permeable filtering portion and a wearer's face.

2. The facemask of claim 1, wherein a channel is formed within the peripheral bottom portion, the unattached portion of the elongate elastic member being positioned within the channel to gather the peripheral bottom portion between the anchored ends.

3. The facemask of claim 2, further comprising a pair of ear loops, each pair having an upper end fixed to the peripheral top portion and a lower end fixed to the peripheral bottom portion, the upper and lower end being positioned along one of the opposing side portions for looping around an ear of a wearer.

4. The facemask of claim 1, wherein the peripheral top portion includes a thin bendable strip of material for conforming to a shape of a wearer's nose.

5. The facemask of claim 1, wherein the peripheral top portion, the peripheral bottom portion, and the opposing side portions comprise a material that inhibits the flow of air therethrough.

6. The facemask of claim 1, wherein the elongate elastic member is anchored to the peripheral bottom portion at an additional position between the opposing side portions.

7. The facemask of claim 1, further comprising a headband configured for retaining the facemask on a wearer's face, each end of the headband being fixed to one of the opposing side portions.

8. The facemask of claim 1, further comprising at least one pair of ties configured for retaining the facemask on a wearer's face, one end of each tie being fixed to one of the opposing side portions.

9. The facemask of claim 1, further comprising a pair of ear loops, each pair having an upper end fixed to the peripheral top portion and a lower end fixed to the peripheral bottom portion, the upper and lower end being positioned along one of the opposing side portions for looping around an ear of a wearer.

10. The facemask of claim 9, wherein each of the upper end and the lower end is fixed by one of ultrasonic welding, gluing, sewing, and combined heat and pressure.

11. The facemask of claim 1, wherein each of the ends of the elongate elastic member is fixed to the peripheral bottom portion by one of ultrasonic welding, gluing, sewing, stapling, and combined heat and pressure.

12. A facemask comprising:
an air-permeable filtering portion comprising air-permeable filtering media, the air-permeable filtering portion configured for positioning over a wearer's nose and mouth to provide an air path therethrough; and
a peripheral top portion, a peripheral bottom portion, and opposing side portions connecting the peripheral top portion to the peripheral bottom portion, the peripheral top, bottom, and opposing side portions forming a periphery of the facemask adapted to fit the facemask to a wearer's face,
wherein the peripheral bottom portion includes at least one elongate elastic member, the at least one elongate elastic member having an extended length that is stretched beyond its relaxed length, the extended length of the elongate elastic member being positioned lengthwise along the peripheral bottom portion between a first position and a second position of the peripheral bottom portion, a first end of the extended length of the at least one elongate elastic member being anchored at the first position and a second end being anchored at the second position, the extended length corresponding to an ungathered width separating the first position from the second position for gathering a section of the peripheral bottom portion between the first position and the second position, the at least one elongate elastic member further comprising an unattached portion between the first and second anchored ends, the unattached portion freely extending and relaxing without constraint to gather the section of the peripheral bottom portion for engaging a chin and face of a wearer during use, the gathered peripheral bottom portion providing an air-inhibiting seal between the air-permeable filtering portion and a wearer's face.

13. The facemask of claim 12, wherein a channel is formed within the peripheral bottom portion, the unattached portion of the at least one elongate elastic member being positioned within the channel for freely extending and relaxing without constraint to gather the peripheral bottom portion for engaging a chin and face of a wearer during use.

14. The facemask of claim 12, wherein the extended length extends across at least half a width of the facemask.

15. The facemask of claim 12, wherein the at least one elongated elastic member includes two or more elongated elastic members, a combined extended length of the two or more elongated elastic members extending substantially across the ungathered width of the peripheral bottom portion.

16. The facemask of claim 12, further comprising a pair of ear loops, each pair having an upper end fixed to the peripheral top portion and a lower end fixed to the peripheral bottom portion, the upper and lower end being positioned along one of the opposing side portions for looping around an ear of a wearer.

17. The facemask of claim 16, wherein each of the upper end and the lower end is fixed by one of ultrasonic welding, gluing, sewing, and combined heat and pressure.

18. The facemask of claim 12, wherein the peripheral top portion includes a thin bendable strip of material for conforming to a shape of a wearer's nose.

19. The facemask of claim 12, wherein each of the first end and the second end of the at least one elongate elastic member is fixed to the peripheral bottom portion by one of ultrasonic welding, gluing, sewing, stapling, and combined heat and pressure.

20. The facemask of claim 12, further comprising at least one pair of ties configured for retaining the facemask on a wearer's face, one end of each tie being fixed to one of the opposing side portions.
